(19) United States
(12) Patent Application Publication
(10) Pub. No.: US 2003/0100339 A1
(43) Pub. Date: May 29, 2003

(54) Real time traffic condition reporting system

(75) Inventors: Kuo-Rong Chen, Panchiao City (TW); Chun-Chung Lee, Taipei (TW); Cheng-Hung Huang, Miaoli Hsien (TW)

Correspondence Address: BACON & THOMAS, PLLC, 625 SLATERS LANE, FOURTH FLOOR, ALEXANDRIA, VA, 22314

(73) Assignee: Sin Etke Technology Co., Ltd, Taipei City (TW)

(21) Appl. No.: 10/083,310

(22) Filed: Feb. 27, 2002

(30) Foreign Application Priority Data
Nov. 26, 2001 (TW) 90220391

(51) Int. Cl. H04Q 7/20

(52) U.S. Cl. 455/556; 455/456; 455/457

(57) ABSTRACT

The invention uses a microprocessor to compare current geometric location information computed by a global positioning unit with geometric location information of traffic condition locations received from a traffic condition control center through a radio transmitting receiving unit, and to select geometric location information of traffic condition locations and corresponding traffic condition information subject to a predetermined condition for output through an output unit. Therefore, the invention provides real time traffic condition information dynamically subject to the current geometric location of the user to fit individual needs.

### BACKGROUND OF THE INVENTION

1. Field of the Invention

The present invention relates to a real time traffic condition reporting system and, more particularly, to such a real time traffic condition reporting system that can be carried on a mobile object movable on the road to dynamically provide the information of traffic conditions subject to the geometric location of the mobile object to fit individual needs. The real time traffic condition reporting system can be used in a motor vehicle, PDA (Personal Digital Assistant), cellular telephone, or any of a variety of portable electronic apparatus.

2. Description of Related Art

When driving a car or walking on the road, we may encounter different traffic conditions, for example, road under-construction, landslide, traffic control, traffic jam, bridge closed, etc. In this case, people may have to make a detour.

In order to avoid passing to the locations where particular traffic conditions occurred, people may receive traffic condition broadcasting of radio stations or dial a service telephone number to receive a voice traffic condition report. However, in order to meet public requirements, regular radio station traffic condition broadcasting or telephone voice traffic condition report provides traffic condition information of a broad geometric zone. This traffic condition broadcasting or telephone voice traffic condition report service cannot provide the traffic condition information of the geometric location of every individual to meet individual's needs. Further, because telephone voice traffic condition report service updates the content after every predetermined length of time, the user cannot obtain real time traffic condition information.

Therefore, it is desirable to provide a real time traffic condition reporting system that eliminates the aforesaid drawbacks.

### SUMMARY OF THE INVENTION

The main object of the present invention is to provide a real time traffic condition reporting system, which dynamically provides real time traffic condition information subject to the current geometric location of the user, so as to meet the needs of the user individually.

To achieve these and other objects of the present invention, the real time traffic condition reporting system comprises a global positioning unit, a radio transmitting receiving unit, an output unit, and a microprocessor. The global positioning unit computes the information of the current geometric location of the real time traffic condition reporting system. The radio transmitting receiving unit receives the information of multiple geometric locations where the traffic conditions occurred and the information of the corresponding traffic conditions. The microprocessor compares the information of the current geometric location provided by the global positioning unit with the information of the geometric locations of the traffic conditions occurred, so as to select the information of the geometric locations of the traffic conditions occurred and the corresponding information of traffic conditions subject to a predetermined condition for output through the output unit.

The predetermined condition can be a particular geometric zone, for example, the area within a particular radius, a particular country, a particular town, a particular mail address zone, or a particular road. The invention can further include a memory device adapted to store the information of geometric locations of traffic conditions occurred and the information of the corresponding traffic conditions. The invention can also further include an electronic map database adapted to store electronic maps for fetching by the microprocessor for further output through the output unit with the selected information of the geometric locations of the traffic conditions occurred and the corresponding information of traffic conditions.

Other objects, advantages, and novel features of the invention will become more apparent from the following detailed description when taken in conjunction with the accompanying drawings.

### BRIEF DESCRIPTION OF THE DRAWINGS

FIG. 1 is a system block diagram of the preferred embodiment of the present invention.

FIG. 2 is a traffic condition information table showing the information of traffic conditions gathered by a remote traffic condition control center according to the present invention.

FIG. 3 is a traffic condition information table showing the information of all traffic conditions received by the radio transmitting receiving unit according to the present invention.

FIG. 4 is a traffic condition information table showing the information of traffic conditions selected subject to a predetermined condition according to the present invention.

FIG. 5 is a traffic condition information chart showing the content of the traffic condition information table indicated in FIG. 4 by graphics.

FIG. 6 is an electronic map and traffic condition information chart showing the information of traffic conditions selected subject to a predetermined condition according to the present invention.

### DETAILED DESCRIPTION OF THE PREFERRED EMBODIMENT

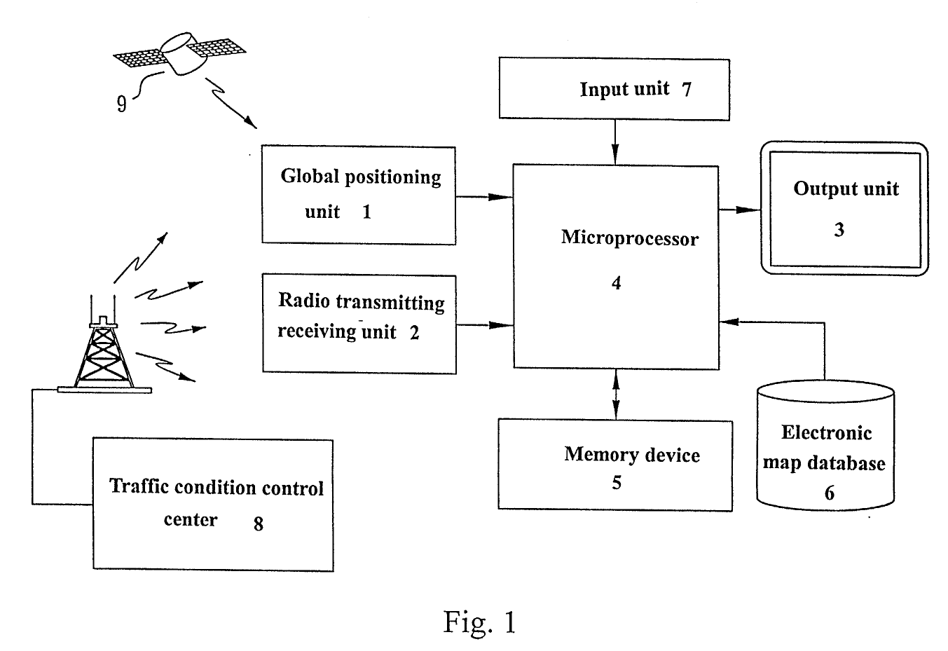

FIG. 1 is a system block diagram of the preferred embodiment of the present invention. According to this embodiment, the traffic condition reporting system is provided on a motor vehicle. Alternatively, the traffic condition reporting system can be provided in any of a variety of portable personal electronic apparatus, for example PDA (Personal Digital Assistant), cellular phone, etc., and adapted to provide real time traffic condition information for individuals subject to the current geometric zone where the user is in presence.

As shown in FIG. 1, the traffic condition reporting system is installed in a car, comprised of a global positioning unit 1, a radio transmitting receiving unit 2, an output unit 3, a microprocessor 4, a memory device 5, and an electronic map database 6.

The global positioning unit 1 according to this embodiment is a GPS (Global Positioning System) adapted to receive signal from multiple artificial satellites 9 in the space and compute the current longitude and latitude coordinates (Xc, Yc) of the car.

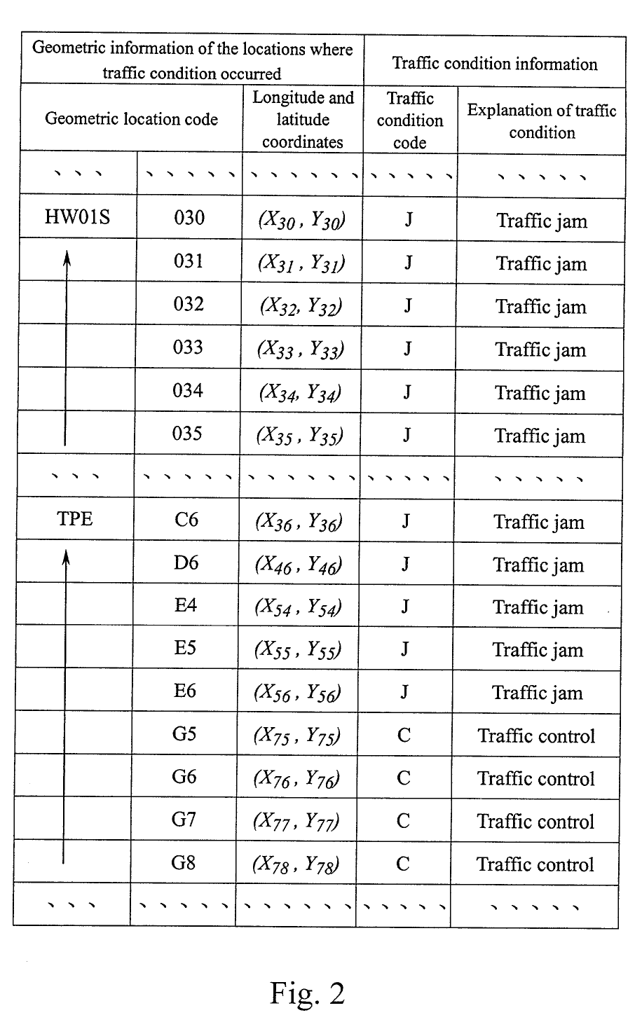

FIG. 2 shows contents of traffic conditions pre-collected by a remote traffic condition control center 8, in which “HW01S” means “First Highway Goes South”; “TPE C6” means “Taipei City C Street 6^{th} Street Intersection”; “J” means “Traffic Jam”; “C” means Traffic Control”. The traffic condition control center 8 broadcasts traffic conditions by radio. According to this embodiment, the radio transmitting receiving unit 2 is a pager adapted to receive broadcasting from the traffic condition control center 8.

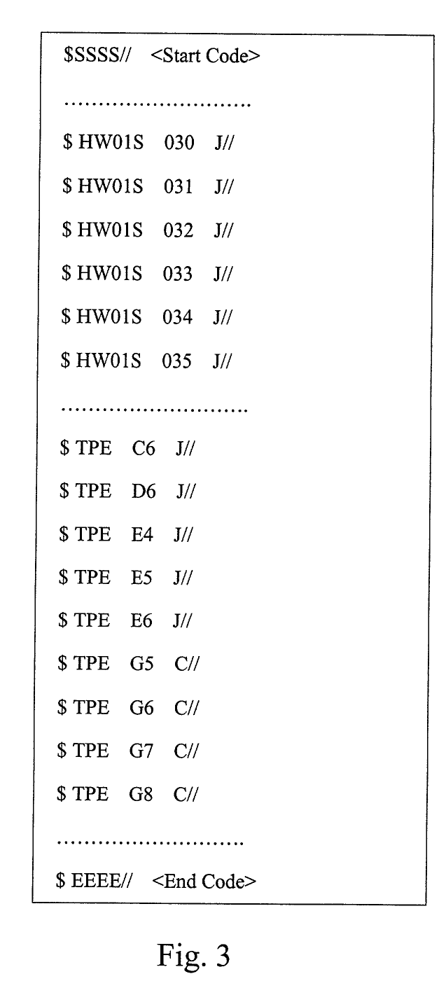

Referring to FIG. 3, in order to reduce the length of transmission data so as to shorten transmitting or receiving time, the traffic condition control center 8 broadcasts the geometric zone code of the respective traffic condition and the traffic condition code of the corresponding traffic condition. The code of geometric zone and the code of traffic condition are received by the radio transmitting receiving unit 2 (pager), and then stored in the memory device 5 for reading by the microprocessor 4. The memory device 5 has stored therein the precision longitude and latitude coordinates (Xi, Yi) of every geometric zone, and/or explanation of every traffic condition code.

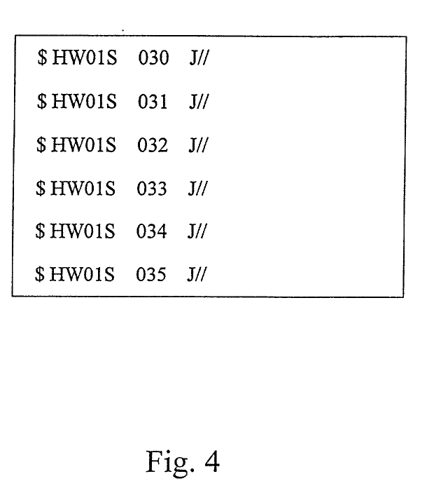

The microprocessor 4 has set therein a predetermined condition, for example, the particular condition of “First Highway (HW01) +Radius 30 km Area”. Therefore, when fetching the current longitude and latitude coordinates (Xc, Yc) of the car from the global positioning unit 1, the microprocessor 4 compares the longitude and latitude coordinates (Xi, Yi) of the geometric zone code of every traffic condition stored in the memory device 5, and then selects the longitude and latitude coordinates (Xi, Yi) of the geometric zones of the traffic conditions that fit the predetermined condition and the corresponding traffic condition information (see FIG. 4).

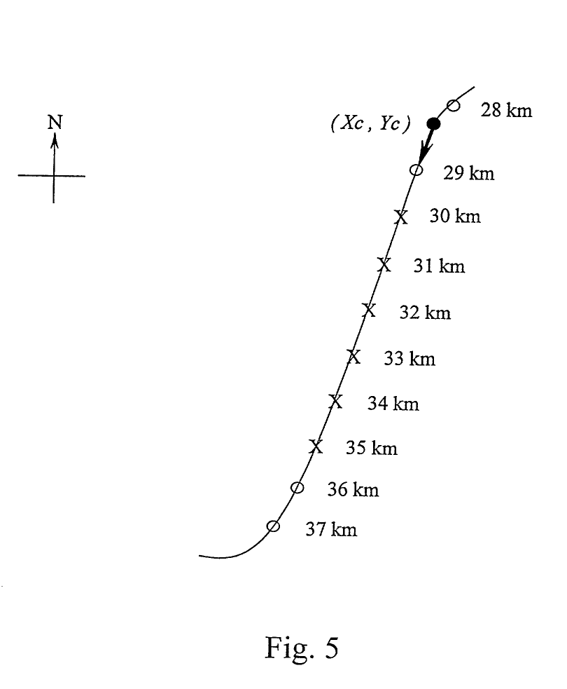

Thereafter, the microprocessor 4 controls the output unit 3 to output selected traffic condition information. The output unit 3 can be a LCD, OSD (On Screen Display), Head-up display, etc. for displaying traffic condition information by letters. Alternatively, the selected traffic condition information shown in FIG. 4 can be displayed by graphics as shown in FIG. 5, in which the marks “X” between the location at 30 km and the location at 35 km means traffic jam locations. Further, voice-synthesizing device may be used to convert traffic condition information into voice for output. Preferably, the microprocessor 4 fetches and broadcasts the traffic condition information of the nearest location in the same forward direction in priority.

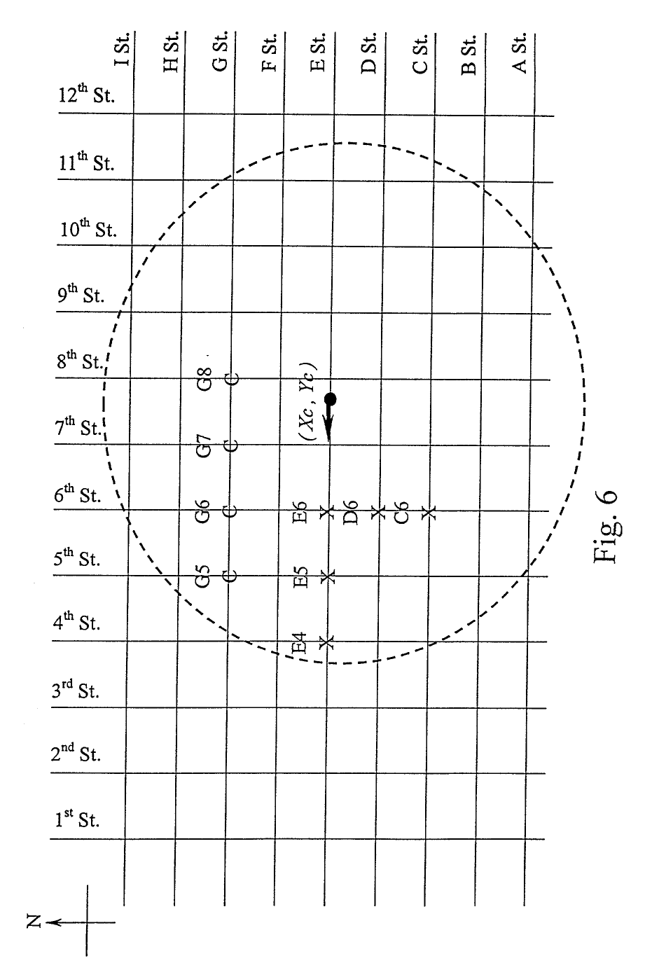

When matched with an electronic map database 6, the microprocessor 4 can read in an electronic map from the electronic map database 6 to display selected traffic condition locations on the display. For example, FIG. 6 displays a Taipei City Electronic Map obtained from the electronic map database 6 subject to the predetermined condition of “Taipei City+Radius 5 km Area” corresponding to traffic condition information shown in FIG. 3 (stored in the memory device 5), in which the mark “X” means traffic jammed intersection; “C” means traffic control location.

Because the traffic condition reporting system computes the current longitude and latitude coordinates (Xc, Yc) of the car subject to the dynamic information provided by the global positioning unit 1 to further compare traffic conditions of different geometric zones broadcasted by the traffic condition control center 8 and to output the selected traffic conditions in time, the invention provides real time traffic condition information to every car driver subject to individual requirement.

Referring to FIG. 1 again, the traffic condition reporting system further comprises an input unit 7 adapted to input or modify the pre-set condition. The input unit 7 can be function keys, a keyboard, or a radio receiver.

The global positioning unit 1 is not limited to GPS. Alternatively, the global positioning unit 1 can be a radio communication network, for example, GSM (Global System for Mobile) network or GPS (Global Positioning System) network adapted to transfer the longitude and latitude coordinates of the nearest three base stations of the message so as to position the current geometric location of the car.

RDS (Radio Digital Broadcasting) or GPRS (General Packet Radio Service) radio broadcasting can substitute for the radio broadcasting of the traffic condition control center 8. If the network has sufficient bandwidth or provides sufficient transmission speed, the traffic condition content broadcasted by the traffic condition control center 8 can be directly transmitted in full detail. If the computing speed of the microprocessor 4 is sufficient to make a direct comparison, the memory device 5 can be eliminated.

Further, the traffic condition control center 8 can arrange and summary every traffic condition in advance, so as to reduce the length of transmission data. For example, it needs to transmit the first and last traffic condition locations (the location at 30 km and the location at 35 km) of six continuous traffic jam locations shown in FIG. 4 and the related traffic condition code only, and the transmission data can be modified to the format of“$HW01S 030 035 J//”.

Although the present invention has been explained in relation to its preferred embodiment, it is to be understood that many other possible modifications and variations can be made without departing from the spirit and scope of the invention as hereinafter claimed.

What is claimed is:

1. A real time traffic condition reporting system comprising:
a global positioning unit adapted to compute the information of the current geometric location of the real time traffic condition reporting system;
a radio transmitting receiving unit adapted to receive the information of multiple geometric locations where traffic conditions occurred, and the information of the corresponding traffic conditions;
an output unit; and
a microprocessor adapted to compare the information of the current geometric location provided by said global positioning unit with the information of the geometric locations of the traffic conditions occurred, so as to select the information of the geometric locations of the traffic conditions occurred and the corresponding information of traffic conditions subject to a predetermined condition for output through said output unit.

2. The real time traffic condition reporting system as claimed in claim 1, wherein said predetermined condition means a selected road.

3. The real time traffic condition reporting system as claimed in claim 1, wherein said predetermined condition means a selected geometric zone.

4. The real time traffic condition reporting system as claimed in claim 1, wherein the information of multiple geometric locations to be received by said radio transmitting receiving unit means codes of the geometric locations where traffic conditions occurred.

5. The real time traffic condition reporting system as claimed in claim 1 further comprising memory means adapted to store the information of geometric locations of traffic conditions occurred and the information of the corresponding traffic conditions.

6. The real time traffic condition reporting system as claimed in claim 1 further comprising an electronic map database adapted to store electronic maps for fetching by said microprocessor for further output through said output unit with the selected information of the geometric locations of the traffic conditions occurred and the corresponding information of traffic conditions.

7. The real time traffic condition reporting system as claimed in claim 1, wherein said global positioning unit is a GPS (Global Positioning System).

8. The real time traffic condition reporting system as claimed in claim 1, wherein the information of multiple geometric locations where traffic conditions occurred and the information of the corresponding traffic conditions to be received by said radio transmitting receiving unit is provided by a traffic condition control center by radio broadcasting.

9. The real time traffic condition reporting system as claimed in claim 1, wherein said radio transmitting receiving unit is a pager.

10. The real time traffic condition reporting system as claimed in claim 1, wherein said output unit is a display.
